(19) United States
(12) Patent Application Publication
(10) Pub. No.: US 2002/0023002 A1
(43) Pub. Date: Feb. 21, 2002

(54) System and method for offline advertising

(76) Inventor: Phillip Staehelin, Prague (CZ)

Correspondence Address: VENABLE, BAETJER, HOWARD AND CIVILETTI, LLP, P.O. BOX 34385, WASHINGTON, DC, 20043-9998, US

(21) Appl. No.: 09/911,696

(22) Filed: Jul. 25, 2001

Related U.S. Application Data
(60) Provisional application No. 60/220,863, filed on Jul. 26, 2000.

(51) Int. Cl. G06F 17/60

(52) U.S. Cl. 705/14

(57) ABSTRACT

A system and method for extending computer network-based data presentation to offline time is provided. Data, such as advertisements, news information, entertainment, etc., can be downloaded during online sessions in periods with otherwise little or no data transmission. Additionally, the downloaded data may be displayed without intruding on the user's workspace. A method according to an embodiment of the invention may run as a background process on the user's computer. When the user initiates an online session, the user's computer may automatically initiate communication with a server to start downloading data. The downloading process may be adjusted to reflect the user's online activity. For example, during periods of significant data transfer, such as during the loading of a new web page, which requires use of a significant amount of bandwidth, the downloading process, for the advertisements or the like, is significantly reduced, or even paused, until sufficient bandwidth is available.

### RELATED APPLICATIONS

This application claims priority from Provisional Application Ser. No. 60/220,863, filed on Jul. 26, 2000.

### FIELD OF THE INVENTION

This invention relates generally to data processing systems, and more specifically, to a system and method for obtaining and presenting data offline and online through customization of the operating system.

### BACKGROUND OF THE INVENTION

A personal computer generally obtains data from the Internet or other on-line source according to an online protocol that requires downloading to thepersonal computers, in real-time, data stored at a network location. For example, advertisements are downloaded to a user's computer from a network location as the ads are being displayed. This process requires network connectivity and may use system resources that are needed by other applications, thereby delaying the processing of these other applications. Further, displaying advertising information according to a conventional method of computer network-based advertising is generally intrusive to the user's workspace. For example, advertising information may be displayed via, for example, a floating bar in the user's workspace.

Alternatively, ads may be buffered into local storage as they are downloaded. This method still requires online connectivity and uses system resources that may be needed by other applications to perform regular refreshing of the ads. Further, the ads are generally displayed in a manner which intrudes on the user's workspace. Also, for purposes of assessing payment, the ads downloaded and displayed must be counted—a process that further uses computer resources that may be needed by other applications.

Accordingly, a need exists for a manner of computer network-based data downloading that overcomes the shortcomings of conventional methods. Namely, extending data display to offline computing time, avoiding data, such as advertisements, being downloaded with every new page view (which generally slows down online activity) and displaying advertisements in a manner that is less intrusive to the user's workspace.

### SUMMARY OF THE INVENTION

This invention provides a system and method for extending computer network-based data presentation to offline time. This invention also allows the downloading of data, such as advertisements, news information, entertainment, etc., to occur during online sessions in periods with otherwise little or no data transmission. Additionally, the downloaded data may be displayed without intruding on the user's workspace. A method according to an embodiment of the invention may run as a background process on the user's computer. When the user initiates an online session, the user's computer may automatically initiate communication with a server to start downloadingdata. The downloading process may be adjusted to reflect the user's online activity. For example, during periods of significant data transfer, such as during the loading of a new web page, which requires use of a significant amount of bandwidth, the downloading process, for the advertisements or the like, is significantly reduced, or even paused, until sufficient bandwidth is available.

According to one embodiment, a method for obtaining and presenting information to a user is provided. Data is received at a user device. The data may be obtained via a downloading process that is adjusted to reflect on-line activity at the first device. The data may then be stored at the first device. The downloaded data can be presented to the user regardless of network connectivity of the user device.

In a further embodiment, it is determined when data is to be downloaded to a first device. It is also detected when the first device is online. When data is to be downloaded and when the first device is on-line, a download of data is initiated at the first device. The data is downloaded based on the on-line activity of the first device. The data may then be presented to the user via the first device, regardless of network connectivity of the first device.

According to another embodiment of the invention, a computer system for providing targeted information to users is provided. A server device is provided as part of the system. The server device includes means for receiving a plurality of information messages, the information messages being associated with at least one of a plurality of target audiences; a profile manager for managing user profiles, the user profiles including information to associate users with the target audiences; a content supplier providing a format of the information message for the user; an upload component storing the plurality of information messages; a server component receiving requests for information messages, the requests including data to associate the request with a user profile; and means for sending information messages in response to the requests, the information messages being determined by comparing the target audience for the information message and the user profiles.

In an exemplary embodiment of the invention, each time a user goes online, the user's computer sends a message to a server, indicating a unique user ID. The user ID may be assigned to the computer after an initial system installation. The message may also include a request for new data, such as the number of ads the computer would like to receive (which, in one embodiment, corresponds to the number of ads that have been viewed). The server confirms the validity of the user ID by, for example, comparing the user ID to a user profile stored on the server. Upon completing this confirmation, the server sends to the user's computer the requested data, such as the number of ads of the type that the user's profile indicates are most suitable (“targeted ads”). The received data or ads may be stored locally on a storage device, such as a hard drive, at the user's computer.

In one embodiment, when data is displayed to, or viewed by, a user it is marked accordingly, and may be overwritten by other data the next time the user goes online.

### BRIEF DESCRIPTION OF THE DRAWINGS

FIG. 1 depicts an exemplary computer network suitable for using the advertising system of the invention;

FIG. 2 depicts an exemplary SQL database;

FIG. 3 depicts an exemplary schema of the data exchange between a client and a server in the invention;

FIGS. 4 and 5 depict further details of the client cache; and

FIGS. 6 and 7 depict flow diagrams of the present invention.

### DETAILED DESCRIPTION OF THE INVENTION

The present invention provides a system and method for obtaining data and for presenting data to a user when the user is both on-line and off-line. Data can be received at the user's computer via a downloading process. The data may include information messages such as advertisements, news articles etc. The downloading process can be adjusted to reflect the on-line activity of the user's computer. As the data is being downloaded, it may be stored at the user's computer, for example on a hard drive. The downloaded data can then be presented to the user, regardless of the network connectivity of the user's computer.

The system and method of the present invention may be implemented in a client server environment, which is well known to those skilled in the art and is not described in detail herein, and the functions may be performed via computer software. In a preferred embodiment, the user's computer may determine when information is required, and initiate a request for information from the server. The server can determine, based on a user profile for the user, which data to provide to the user's computer. The system and method of the present invention are particularly suited for use in on-line advertising and is described below in that context. However, it will be recognized by those skilled in the art that the invention can be applied to many other environments.

The system and method of the invention may use various screens, including, for example, the desktop/wallpaper, startup and shutdown screens, and screen savers to display data and information to users. Existing PC functionality can be utilized to display information to a user's desktop. The data may be delivered to the user in a variety of formats, including, for example, video, or audio. In this invention, unlike in conventional online advertising systems, the user's computer may initiate the communication with the server to request, for example, advertising information. This makes it much easier for advertisements to be delivered through, for example, corporate firewalls.

The data can be downloaded to the user's computer from a server. The downloaded data may be stored at the user's computer in, for example, an “ad battery”. The downloaded data may then be displayed to the user. Thus, a user need only be online for the time required to request and receive data from the server. The downloaded data can be stored locally and displayed to the user regardless of network connectivity. For example, ad screensavers may be displayed while a user is online or offline.

In an exemplary embodiment, which data is presented to the user is tracked. For example, once an ad has been displayed to a user, a software program resident on the user's computer marks the ad accordingly and displays a different ad the next time. Each time a user goes online, i.e., establishes a network connection, data that has already been displayed may be replaced with new data, i.e., new ads are downloaded to the user's PC and stored in the ad battery. If the user does not go online during a specified number of PC sessions and the local supply of unseen ads is exhausted, the ads stored in the ad battery may be re-displayed to the user. These additional displays may or may not be tracked.

Ads may include an ad-rating feature that allows a user to rate the ad. This feature may be in the form of, for example, selectable radio buttons marked with various rankings, e.g. poor to excellent. This rating information may be aggregated and saved by the system, and sent to the server at specified times. Users may be rewarded for rating ads.

As mentioned above, if a user does not establish a network connection for, for example, two consecutive computer sessions, previously viewed ads (those ads stored in the local ad battery) may be rotated and re-displayed to the user. Because the system tracks the ads displayed, it can determine how much to charge an advertiser based on the number of clients sent the ador the number of times the ad is viewed. Each advertiser is typically charged once, for one ad display. Thus, when ads are rotated, the advertiser may not be charged for additional displays of the ads.

The software resident on the user's computer may automatically be loaded at boot-up. The software can include a system tray icon that is visible to the user. This icon allows the user to change the system settings. For example, when the icon is double-clicked, a modified preference screen may appear. The screen allows the user to: turn off the program during the current user session, and temporarily or permanently disable or re-enable ad space, or data display, functionality. This preference screen may also include a history of the previous ads that were displayed, for example, the last twelve ads and html links to the advertiser for each may be displayed on this modified preference screen. A user may also temporarily disable the system via the system tray icon. If the system is temporarily disabled, no ads will be shown for the remainder of the current session, but ads will be displayed during the next boot-up. Furthermore, the wallpaper and screensavers can incorporate a “live link button” which also activates a browser and takes the user to the advertiser's site. The system may also provide additional features. For example, a user may “touch” a screensaver without removing it by holding the “Shift” key down before moving the cursor (and during the mouse movement and click).

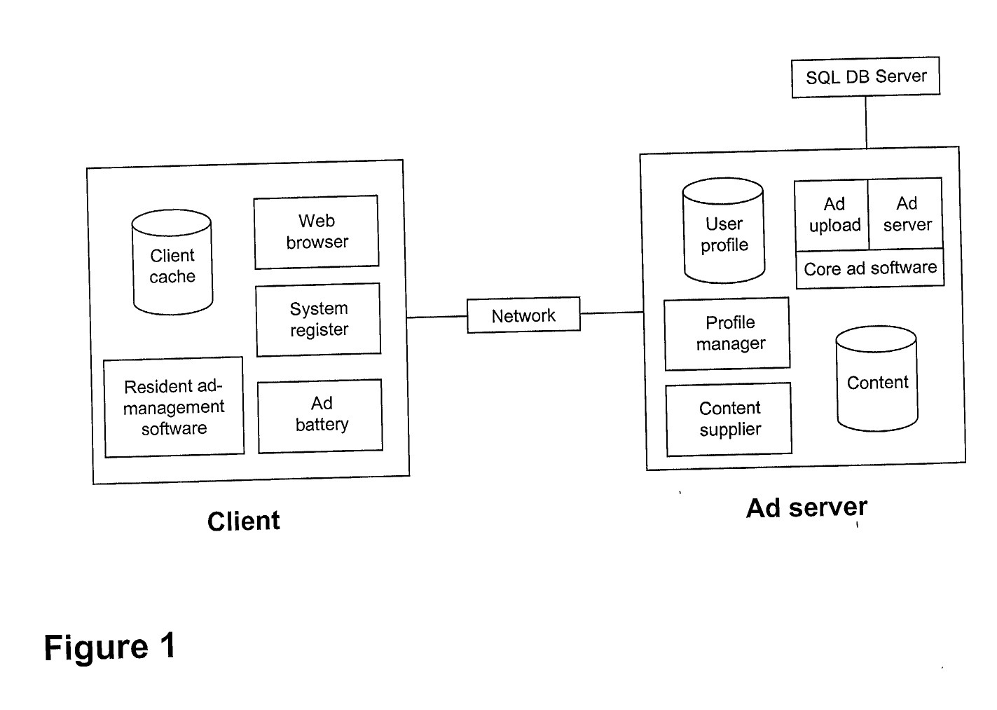

FIG. 1 depicts an exemplary computer network suitable for using the online/offline system of the present invention. The network includes, for example, a client and a server. The client may include a client cache, a system register, and a web browser, such as, Microsoft Internet Explorer™. The client may be installed on, for example, a workstation running a Microsoft Windows™ operating system. The server can serve as a conduit between information providers, such as third party advertisers, and the user's computer. That is, the server serves as the hub for communication and transactions between users and advertisers. Advertisers send ads to the server and indicate a target market for the ad. The ad may be stored at the server and sent to a user when the user's computer makes a request. Ads can be sent to any number of users, depending on, for example, the number of people the advertiser has paid to reach.

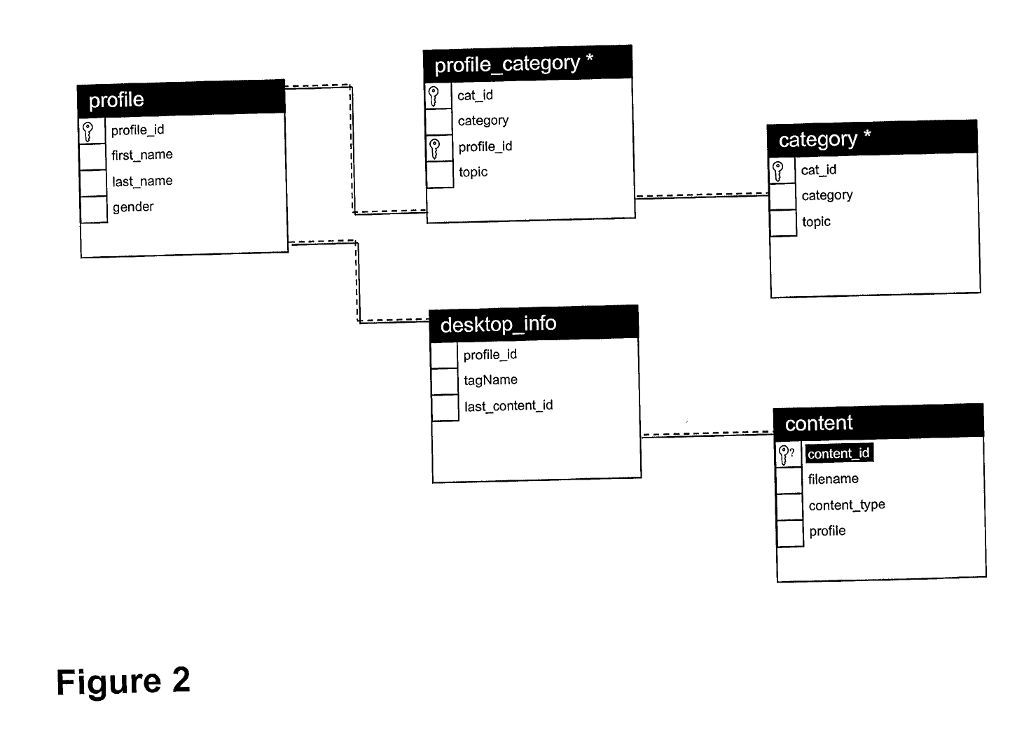

The server may run on a machine running, for example, Java Servlet Engine implementing Java Servlet API 2.1. The server may also be connected to an SQL database server that has a suitable JDBC driver. This database stores user profile and resource information for users. FIG. 2 depicts such an exemplary SQL database.

The server is a basic technological component and may have multiple functionality. The server may be one or more servers that are able to function together to provide a certain functionality. Specific tasks may be split between physical servers, or they may reside on the same server. According to one embodiment of the invention, the server identifies a user, via the ID, for example, and determines which data, such as ads, are available for download by the client. This may be done by classifying ads by profile groups, etc. As described above, the ads may be stored in the ad bank and the server should also determine the address from which the ads will be downloaded. This address is then provided to the client. The client can then begin the download at the earliest possible time. This data may be delivered by the same server, or a physically separate server, depending on server availability.

In the disclosed embodiment, the server may include two services: a profile manager, and a content supplier. The profile manager manages user profiles. It includes various fields for collecting profile information from the user. A user's profile may include, for example, name, address, hobbies, etc. This profile information may be stored on the server and may be used when delivering ads to the client. Several clients may share the same profile. The profile manager can distinguish between clients with the same profile to track ads. Users may be divided into groups according to their user profile information. Each group may be targeted to receive specific ads. The content supplier service provides a client with different wallpaper images, screensavers, startup and shutdown screens, etc. The content supplier service may, but does not necessarily, consider profile settings when sending ads to the client.

The server stores a user profile for each registered system user, and stores the ads that may be provided to a client. Communication between the client and the server occurs over a network using, for example, the HTTP and XML protocols. System features may further be accessible through a proxy server that supports the HTTP protocol. The server may be localized geographically, in a country or region. This allows for local advertising content, and localizes risks associated with a server crashing. The server may include two components: an ad upload area and an ad server area. The ad upload area stores ads which have been created and approved for client presentation. Ads may be specially “tagged” for display to specific users, according to a user's indicated preferences, or other profile information, described further below. While this tag may allow for overlap between user profiles, it may also be very specific, limiting the presentation of certain ads to specific clients. The other component of the server, the ad server, receives an ad reload request from the end user's PC and responds by sending new ads to the user. It determines which ads to send according to the user profile stored on the server.

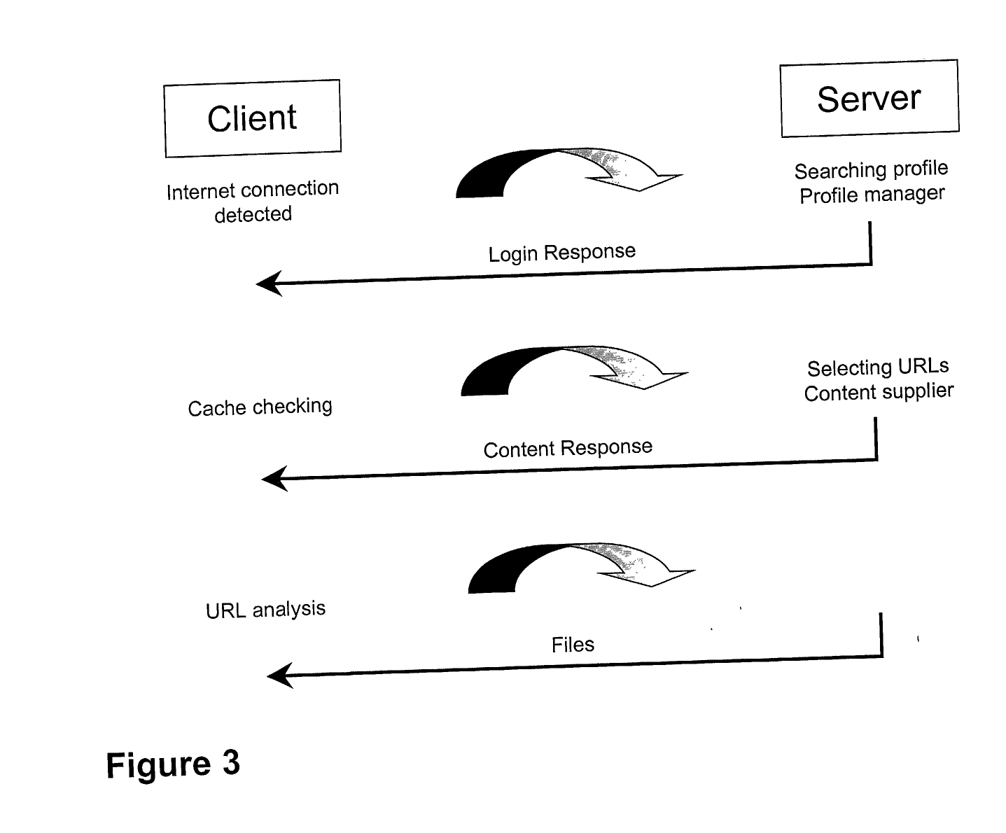

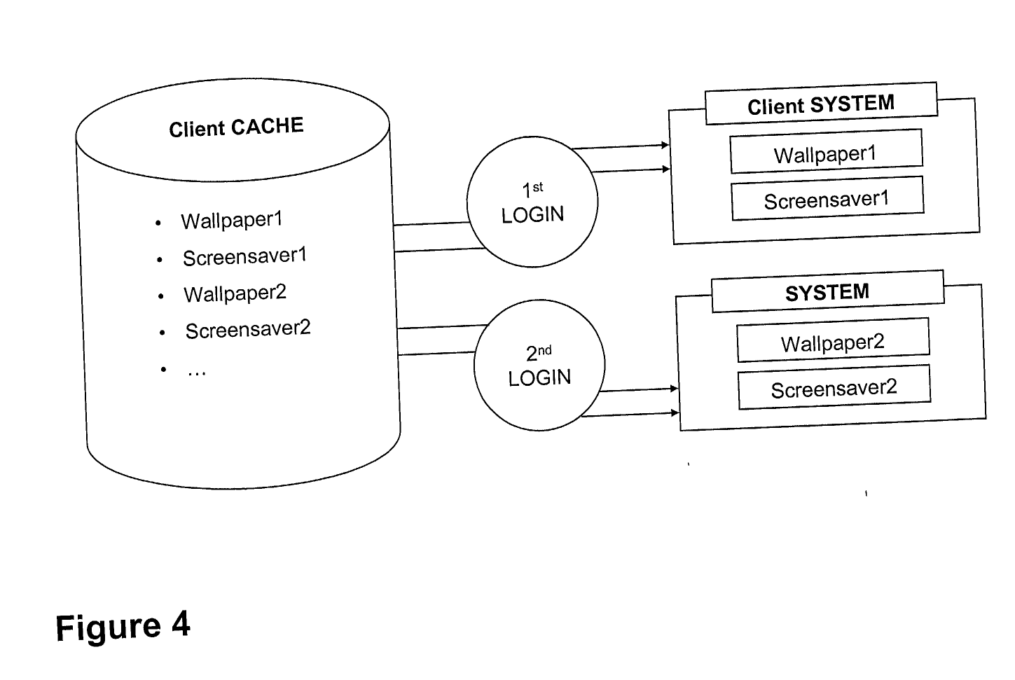

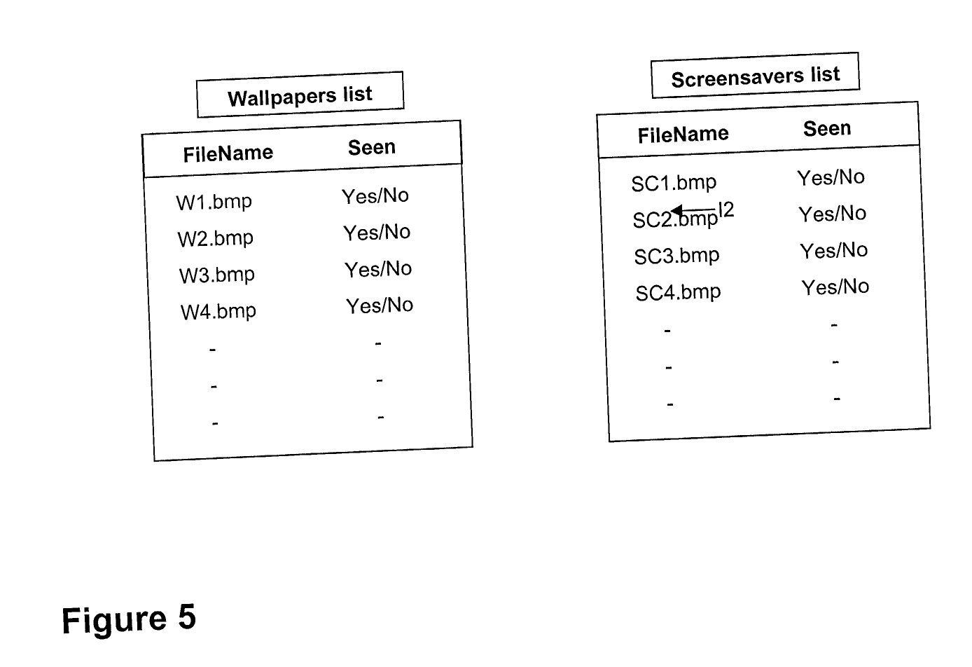

FIG. 3 depicts an exemplary schema of the data exchange between a client and a server when a network connection is detected. When the client logs in to the server, the server searches, for example, a profile manager to determine the profile of the client. When a user establishes a network connection, the client checks a cache, explained further below relative to FIGS. 4 and 5, to determine which resources need to be refreshed and initiates a communication with the server. According to the information stored about the content that has been downloaded to it, the client can determine which resource(s) have already been displayed and should be overwritten with new data.

FIGS. 4 and 5 depict further details of the client cache. The client cache can maintain a separate list for different types of ads that are downloaded (e.g., wallpaper, screensaver, etc.). For each ad type, the filename of a particular ad and an indication of whether the ad has been displayed are stored. The client cache farther includes an index for each list that points to the resource that is currently in use. According to the information in the client cache, the client determines which resources, i.e., ad types, have already been displayed and should be refreshed. The client application may be, for example, native Win32, running in the system tray. In the case of, for example, screensaver ads, the system register keeps track of whether a particular screensaver ad has been displayed, or viewed. Generally, rather than maintaining a log of which ads have been displayed, it “marks” or “flags” a particular ad as having been displayed. Thus, when an ad is displayed to the user, it is indicated, or “marked,” as being displayed (or viewed). This flagging or marking may be done in code. Detailed information about which ads have been displayed may be stored at the user's computer and updated when a previously displayed ad is overwritten with a new one.

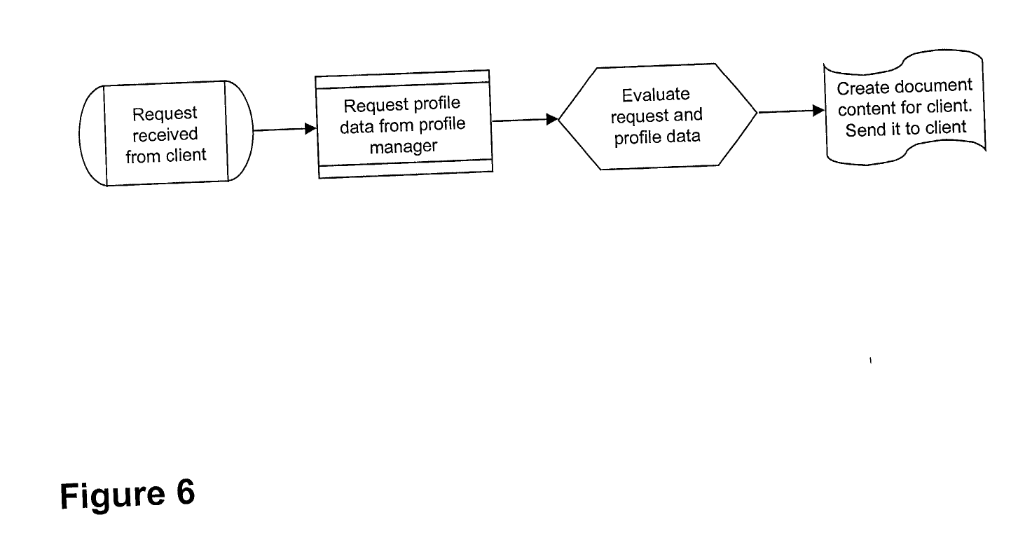

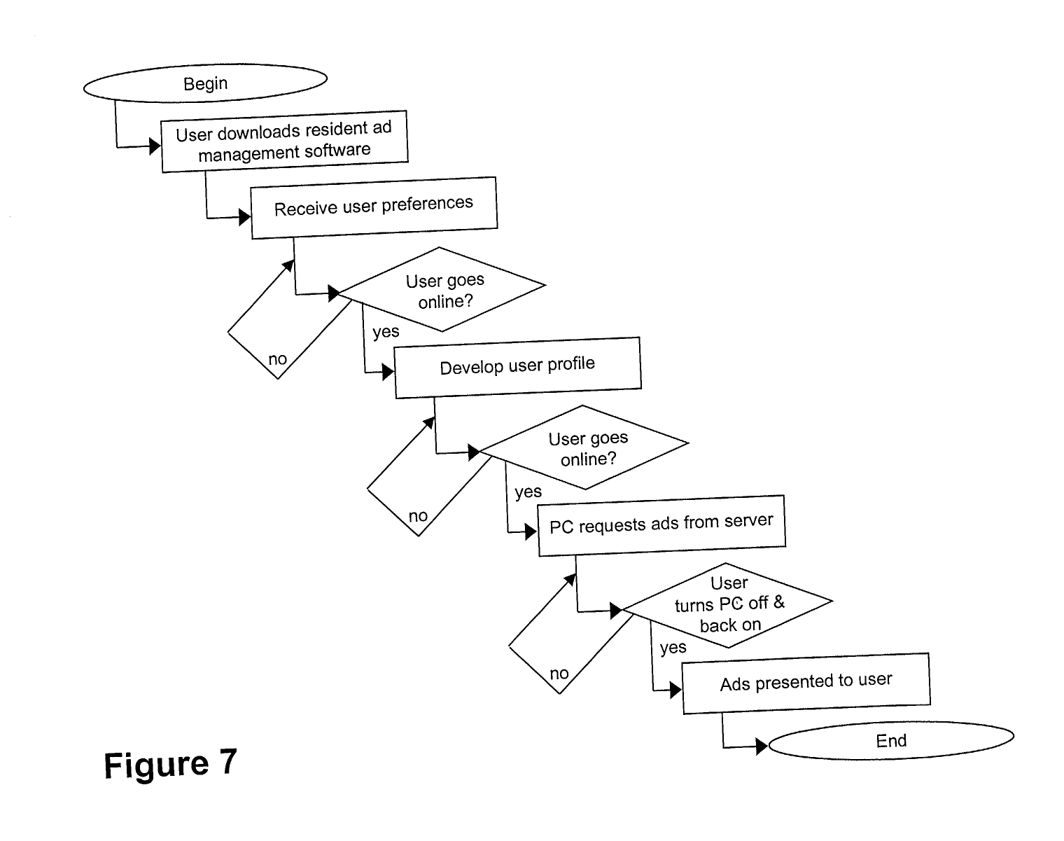

FIGS. 6 and 7 depict flow diagrams of an embodiment of the present invention. A user downloads the system software to a client computer. Once the compressed, self-installing file is fully downloaded, double-clicking on it launches the installation program. A profile window is then displayed to the user, asking the user to enter certain information that will be used to develop his profile. This may include information about the user's specific preferences for receiving information. The profile information is then stored on the user's computer until the next online session (after the first re-boot) at which point it is sent to the server. Via the preference screen, a user may answer personal questions, such as age, sex, educational level, salary, hobbies, etc. The user may further indicate what type of information is preferred and which is not preferred. For example, the preference screen may allow a user to affirmatively decline particular advertisements, or types of advertisements. After the user has completed the profile window's data requests, the computer is re-booted (then or later) to complete installation of the software. During the next online session, the server generates a unique profile identification code for the user and sends a copy of the code back to the client for storage. This profile registration should execute only once, upon the initial installation of the system.

The next time a user establishes a network connection, the unique user ID is provided to the server and is checked against the stored user profile, allowing for information, such as ads, to be properly targeted according to the profile. The server may also analyze the user's IP address to determine additional user information (such as geographic location, type of browser used, etc.). The stored preference information and the IP address analysis can be used to develop an accurate user profile. Users can then be grouped according to their profiles into various advertiser-requested classifications.

During the next online session, the user's computer, i.e., the software application on the client device may send a login request to the server. The login request should include information that allows the profile manager to identify the user, for example, an indication of the client's unique user ID. A content information request may also be sent to the server. The content information request should include a request for data from the server and may be included with the login request. If the client does not have a user identification code, when sending the content information request to the server, a default user identification code, for example, 0 may be used. In response, the server assigns the client a user identification code. A login request may include the following:

http:“\\server\servlet\profile?ProfileID=1234.

In response to the request, the server replies with a login packet response. The login packet response to the client may include a content manager address and specify content periods. This reply may be in the form of XML. The content manager address indicates from where the new ads will be downloaded, and the content periods indicate the frequency with which ads may be changed. For example, the wallpaper may be changed only once, five minutes after login. Similarly, startup or shutdown screens may be changed each time they are presented. When the client receives this content manager address and content period information, it sends a content information request to a content manager. The content manager may be a server or a portion of a server dedicated to act as a “librarian” for data, such as ads. A request for a specific ad is fulfilled by the content manager, that is, a specific ad is made available for downloading by the client. The content manager can also ensure that the advertisers get only the exposure that they paid for, for example, delivery of ads to a certain number of users. When enough users view a specific ad, the content manager ensures that a different ad (that matches the user's profile) is delivered. A login response packet from the server may include the following:

<XML>

<LOGIN>

<CONTENT MANAGER>

<CMPARM NAME=“Address” VALUE=“content Manager URL”/>

</CONTENT_MANAGER>

<TIMEOUTS>

<TIMEOUT NAME=“Relogin” VALUE=“[−1[n]”/>

<TIMEOUT NAME=“Wallpaper” VALUE=“[−1[0]n]”/>

<TIMEOUT NAME=“ScreenSaver” VALUE=“[−1[0]n]”/>

<TIMEOUT NAME=“Startup” VALUE=“[−1[0]n]”/>

<TIMEOUT NAME=“Login” VALUE=“[−1[0]n]”/>

</TIMEOUTS>

</LOGIN>

</XML>

In the above example, the following timeout values may be used: “−1”=do not perform action; “0”=request now; and “n”=number of minutes to wait. The client uses URLs from the response packet to obtain new resources. One of ordinary skill in the art will appreciate that the URLs may point to zipped files to decrease the transfer time.

After a content information request is made, the content manager may respond back to the client with a response including the following:

<XML>

<CONTENT [ATTRIB=“UserID”]>

<CITEM NAME=“LoginDlg” VALUE=“valid url”/>

[

<CITEM NAME=“Wallpaper” VALUE=“valid url”/>

<CITEM NAME=“Startup” VALUE=“valid url”/>

<CITEM NAME=“Screensaver” VALUE=“valid url”/>

]

</CONTENT?>

[

<SYSTEM>

<SYS NAME=“Message”>

Message text goes here.

</SYS>

<SYS NAME=“Action” VALUE=“relogin”>

<ISYS>

</SYSTEM>

]

</XML>

During an online session, the user's computer may request data, such as ads, from the server. When the user establishes a network connection, the client checks its cache to determine which data need to be refreshed or replaced and if some of the data need to be refreshed or replaced, initiates a communication with the server. In this request, the user's computer may request a specific amount of data, for example a specific number of ads. These ads will be presented to the user during the next PC sessions. The ads may include two startup screens, four wallpaper screens, four screen savers, and two shutdown screens. Therefore, when the user next turns on the PC, one of the startup screen ads will be displayed. Immediately thereafter, the first wallpaper ad may be displayed. After a specified period of time, e.g., five minutes, the wallpaper may be switched to a second wallpaper screen, depending on the content period. During this PC session, if the computer sits idle for a specified period of time, e.g., two minutes (or another time indicated by the PC's desktop settings), an ad screensaver may be displayed. When the user shuts down the system, a shutdown ad may be displayed. One of ordinary skill in the art will appreciate that while the various ads have been given descriptive names, different ad screens may be available with different operating systems. For example, for users using a PC running Windows 2000, there will be a pre-login screen instead of the startup screen, and there will be no shutdown screen.

The system may further include a process for determining whether an ad has actually been viewed. A “proven view” may be defined as any time when all programs and windows are closed during a user session, giving a clear and unobstructed view of the wallpaper. In this case, instead of ads being changed according to a pre-set time schedule, ads may be changed after a proven view.

Although the foregoing description has been described with reference to a specific implementation, those skilled in the art will know of various changes in form and detail that may be made without departing from the spirit and scope of the invention. For example, ads may be delivered to users in a variety of presentation formats, including audio, video, and scent. Moreover, instead of personal computers, the data can be downloaded to PDAs, wireless phones, WAP devices, etc.

I claim:

1. A method for obtaining and presenting data to a user, comprising:
receiving data at a user device, the data being received via a downloading process that is adjusted to reflect on-line activity at the first device;
storing the data at the first device; and
presenting the stored data to the user regardless of network connectivity of the user device.

2. The method according to claim 1, further comprising:
determining when specific sets of data are presented to the user; and
requesting new data to replace the presented data.

3. The method according to claim 2, wherein the specific sets of data are advertisements.

4. The method according to claim 1, wherein the user device initiates the downloading process.

5. A method for obtaining and presenting data to a user, comprising:
determining when data is to be downloaded to a first device;
detecting when the first device is online;
when data is to be downloaded and when the first device is on-line, initiating a download of data at the first device, the data being downloaded based on on-line activity of the first device; and
presenting the data to the user via the first device, regardless of network connectivity of the first device.

6. The method according to claim 5, further comprising storing the downloaded data at the first device.

7. The method according to claim 5, further comprising:
providing user profile information from the first device to a second device; and
receiving data from the second device, the data being selected based on the user profile information.

8. The method according to claim 5, wherein the first device is a personal computer.

9. The method according to claim 8, further comprising storing the downloaded data on a storage device of the display device.

10. The method according to claim 7, wherein the initiating step comprises:
sending a log-in request from the first device to a second device every time the first device goes on-line.

11. The method according to claim 10, wherein the log-in request includes a user ID.

12. The method according to claim 7, further comprising sending a content information request to the second device.

13. The method according to claim 7, wherein the second device is a server.

14. The method according to claim 5, further comprising setting a flag associated with the data that is presented to the user.

15. The method according to claim 14, wherein the determining step comprises:
checking the flag for the data; and
requesting new data for each data with its flag set.

16. The method according to claim 15, wherein the new data replaces the data with its flag set.

17. The method according to claim 5, wherein the data includes advertisements.

18. The method according to claim 17, wherein the advertisements are presented to the user as at least one of a screensaver, wallpaper, a start-up screen, and a shut-down screen.

19. The method according to claim 5, wherein the presenting step comprises selecting specific ones of the data to present to the user; and
tracking the specific ones of the data presented to the user.

20. The method according to claim l9, wherein the selecting step comprises:
selecting data that has not previously been presented to the user; and
if no data remains that has not previously been presented to the user, re-presenting data to the user.

21. A method of providing data to a user device, comprising:
receiving a request initiated by a user device, the request including a user ID;
associating the user ID with a user profile;
determining, based on the user profile, select data to be provided to the user device; and
downloading the select data to the user device based on on-line activity of the user device.

22. The method according to claim 21, further comprising receiving the data from a third party, the data to be provided to users based on a target audience, the third party having no knowledge of the user profiles.

23. The method according to claim 21, further comprising receiving a user profile from the user device when the user device initially logs-in.

24. The method according to claim 21, wherein the user profile includes at least one of a name, address, hobbies, education level, salary or other characteristics of a user.

25. The method according to claim 21, wherein the data includes advertisements.

26. The method according to claim 25, wherein the user profile indicates a type of advertisement the user wishes to receive or has been selected, based on his profile, to receive.

27. The method according to claim 21, wherein the request includes a content information request.

28. The method according to claim 27, further comprising, in response to the content information request, providing a content response including an address where the data to be downloaded is located, to the user device.

29. The method according to claim 28, wherein the address is an URL address.

30. A computer system for providing targeted information to users, comprising:
a server device including:
means for receiving a plurality of information messages, the information messages being associated with at least one of a plurality of target audiences;
a profile manager for managing user profiles, the user profiles including information to associate users with the target audiences;
a content supplier providing a format of the information message for the user;
an upload component storing the plurality of information messages;
a server component receiving requests for information messages, the requests including data to associate the request with a user profile, and sending information messages in response to the requests, the information messages that are sent being determined by comparing the target audience for the information message and the user profiles.

31. The system according to claim 30, wherein some of the plurality of information messages is provided to a plurality of users.

32. The system according to claim 30, further comprising a means for charging based upon the number of users a message is provided to.

33. The system according to claim 30, further comprising a client including:
means for obtaining profile information from a user;
means for determining that new information messages are needed;
means for initiating communication with the server to retrieve the new information messages; and
means for tracking the presentation of information.

34. The system according to claim 33, wherein the server device further comprises means for generating a unique user ID for the client devices.

35. The system according to claim 30, wherein a number of users are grouped together in a user profile.

36. A computer useable information storage medium storing computer readable program code means for causing a computer to perform the steps of:
determining when data is to be downloaded to a first device;
detecting when the first device is online;
when data is to be downloaded and when the first device is on-line, initiating a download of data at the first device, the data being downloaded to the first device based on on-line activity of the first device; and
presenting the data to the user via the first device, regardless of network connectivity of the user device.
